(19) United States
(12) Patent Application Publication
(10) Pub. No.: US 2007/0184859 A1
(43) Pub. Date: Aug. 9, 2007

(54) Method of managing messages which have been sent by a electronic device

(75) Inventors: Christian Kraft, Frederiksberg C (DK); Peter Dam Nielsen, Kgs Lyngby (DK)

Correspondence Address: HARRINGTON & SMITH, PC, 4 RESEARCH DRIVE, SHELTON, CT, 06484-6212, US

(73) Assignee: Nokia Corporation

(21) Appl. No.: 11/351,362

(22) Filed: Feb. 9, 2006

(51) Int. Cl. H04Q 7/20

(52) U.S. Cl. 455/466

(57) ABSTRACT

The Figures illustrate a method of managing messages which have been sent by an electronic device including sending a message from the device; determining, within the device, whether the message has been delivered within a predetermined time; and if the message has not been delivered within the predetermined time controlling the device to present a notification to a user of the device that the message has not been delivered.

### FIELD OF THE INVENTION

Embodiments of the present invention relate to a method of managing messages which have been sent by an electronic device. In particular, they relate to a method of managing SMS or MMS messages which have been sent by an electronic device.

### BACKGROUND TO THE INVENTION

Often when a message, such as an SMS or MMS message, is delivered, the device which sent the message will receive a delivery report informing the user of the device that the message has been successfully delivered. The receipt of these delivery reports can often be inconvenient, as the delivery report may be delivered several hours after the message has been sent. If a number of messages were sent to the same number at a similar time it is difficult for the user to determine which messages have been successfully delivered.

It would be desirable to improve how messages are handled by the device.

### BRIEF DESCRIPTION OF THE INVENTION

According to one embodiment of the invention there is provided a method of managing messages which have been sent by an electronic device comprising:
sending a message from the device; determining, within the device, whether the message has been delivered within a predetermined time; and if the message has not been delivered within the predetermined time controlling the device to present a notification to a user of the device that the message has not been delivered.

This provides the advantage that the user can be immediately notified if the message has not been delivered within a predetermined time. For example, if a user was to send a message arranging a meeting at a given time, then if they are informed that the message has not been delivered by that given time they can make alternative arrangements. According to one embodiment the notification also includes options to allow the user to do something relating to the undelivered message, for example send the message to a new number or send a new message.

Since the user is notified if the message has not been delivered, the user can avoid being disturbed with unwanted delivery reports.

According to one embodiment the user can determine the time by which he wishes to be notified, if the message has not been delivered.

According to another embodiment of the invention there is provided an electronic device comprising: a transceiver for transmitting and receiving messages; and control means, for controlling the device, arranged to determine, whether a message, sent by the device, has been delivered within a predetermined time, and, if the message has not been delivered within the predetermined time, to present a notification to a user that the message has not been delivered.

A computer program comprising program instructions for controlling an electronic device which, when loaded into a processor, provides: means for correlating information relating to messages sent by the device with notification of delivery messages received by the device; and means for initiating a notification that a first message, sent by the device, has not been delivered, if a notification of delivery message has not been received and correlated with the first message within a predetermined time.

### BRIEF DESCRIPTION OF THE DRAWINGS

For a better understanding of the present invention reference will now be made by way of example only to the accompanying drawings in which:

FIG. 1 schematically illustrates an electronic device;

FIGS. 2A to 2C illustrate flow charts showing method steps of an embodiment of the present invention;

FIGS. 3A to 3F illustrate an embodiment of the present invention in use.

### DETAILED DESCRIPTION OF EMBODIMENTS OF THE INVENTION

The Figures illustrate a method of managing messages which have been sent by an electronic device 1 comprising: sending a message 43 from the device 1; determining, within the device 1, whether the message 43 has been delivered within a predetermined time; and if the message 43 has not been delivered within the predetermined time controlling the device 1 to present a notification 51 to a user of the device 1 that the message 43 has not been delivered.

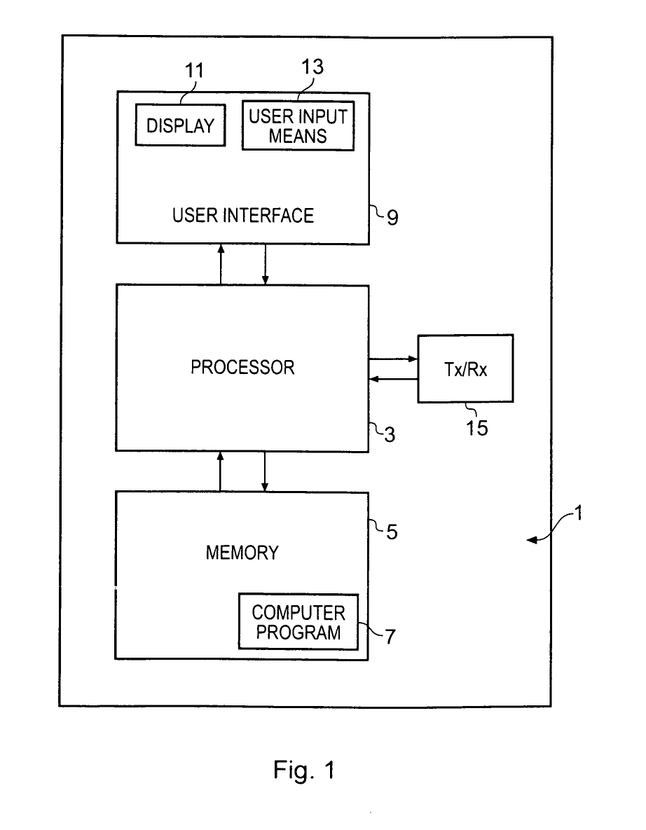

FIG. 1 schematically illustrates an electronic device 1. Only the features referred to in the following description are illustrated. It should, however, be understood that the device 1 may comprise additional features that are not illustrated. The electronic device 1 may be, for example, a personal computer, a personal digital assistant, a mobile cellular telephone, or any other electronic device that allows a user to send and receive messages.

The illustrated electronic device 1 comprises: a user interface 9, a memory 5, a processor 3 and a transceiver 15. The user interface 9 comprises a display 11 and user input means 13. The user input means 13 may be any means which allow a user to input information into the device 1 including, for example, a key pad, a joystick, a roller, voice recognition means or a touch sensitive region of the display 11.

The processor 3 is connected to receive input commands from the user input means 13 and to provide output commands to the display 11. The processor 3 is also connected to write to and read from the memory 5.

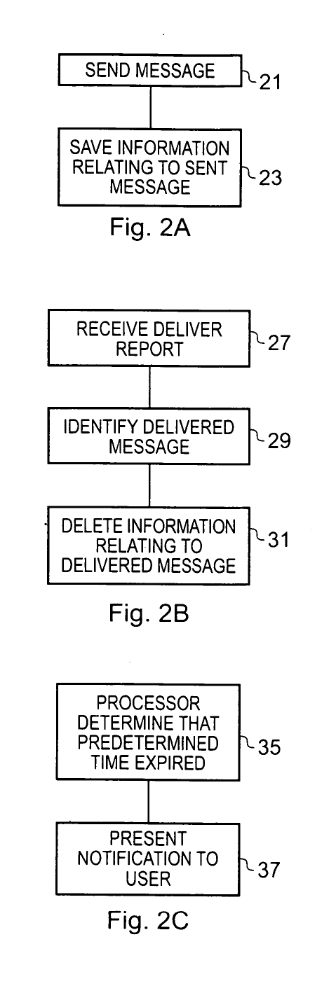

The memory 5 stores computer program instructions 7, which when loaded into the processor 3, enable the processor 3 to control the operation of the device 1 as described below. The computer program instructions 7 provide the logic and routines that enables the electronic device 1 to perform the method illustrated in FIGS. 2A to 2C.

The computer program instructions 7 may arrive at the electronic device 1 via an electromagnetic carrier signal or be copied from a physical entity such as a computer program product, a memory device or a record medium such as a CD-ROM or DVD.

The transceiver 15 is controlled by the processor 3 and enables the electronic device to send and receive messages.

A method of controlling the device 1, according to the present invention, is illustrated schematically in FIGS. 2A to 2C.

FIG. 2A illustrates the method steps involved in sending a message 43 according to an embodiment of the invention. At step 21 the user of the device 1 sends a message 43. The message 43 may be an SMS message, an MMS message, an email or any other type of message that can be sent by an electronic device. The message 43 may include information which has been input into the device 1 via the user input means 13. The message 43 may also include information that has been downloaded into the device 1 and stored in the memory 5.

Before the message 43 is sent the user may be given the option to activate a delivery failure notification function for the message 43. The delivery failure notification function allows a user to receive a notification in the event that the message 43 is not delivered within a predetermined time. The user may also be able to set the predetermined time, by which they wish to receive such a notification. The predetermined time may be different for each message.

The predetermined time may be dependent upon the recipient of the message, for example, the user may wish to set the predetermined time to be shorter for messages sent to work colleagues than for messages sent to friends and family members. The predetermined time may be dependent upon the content of the message, for example, if the message refers to a calendar event or a specific time and date, the predetermined time may be set in relation to that event or time.

Alternatively the user may be able to activate the delivery failure notification function as a general setting which applies to all messages sent by the device 1. Where the delivery failure notification function is arranged as a general setting the predetermined time may be the same for all messages sent by the device.

If the delivery failure notification feature has been activated then, at step 23, once the message 43 has been sent, the device 1 saves, information relating to the sent message 43. The saved information may be stored as an entry in a database, in the memory 5, together with entries relating to other messages which have been sent by the device 1.

According to one embodiment the saved information includes an identifier of the message 43. The information may also include information relating to the time at which the message was sent and the time at which the user wishes to be notified if the message 43 has not been delivered.

FIG. 2B illustrates the method steps which occur if the message 43 is delivered within the predetermined time. At step 27 the device 1 receives a delivery report. There may be some time delay between the sending of the message 43 and the receipt of the delivery report if there has been a delay in the delivery of the message 43.

Generally messages which are received by the device 1 enter the inbox of the device. If the delivery failure notification function has been activated then the device 1 may filter out the delivery report messages so that any received delivery report messages do not enter the inbox, but any other received messages do enter the inbox. The delivery report messages may be stored in a separate inbox to other received messages. Alternatively, the delivery report messages may enter the inbox as any other message, however the user may be able to arrange the device 1 so that they do not receive alerts when a delivery report enters the inbox.

At step 29 the processor 3 identifies the message 43 that has been delivered. The delivery report message comprises an identifier identifying the delivered message 43. The processor 3 compares the identifier of the delivery report with the information relating to the sent messages stored in the database to find the corresponding identifier of the message 43 which has been delivered. At step 31 the processor 3 removes the entry relating to the delivered message 43 from the database. If the delivery report has entered the inbox, the processor 3 may also delete the delivery report from the inbox so that the user does not have to read unwanted delivery reports.

If there is no information relating to the delivered message 43 stored in the database, for example, if the user has not activated the delivery failure notification function for that particular message 43, then the delivery report may enter the inbox and the user may be alerted that a delivery report has been received.

The method steps which occur if the message 43 is not delivered within the predetermined time are illustrated in FIG. 2C. At step 35 the processor 3 determines that the predetermined time has expired and the message 43 has not been delivered. The presence of an entry for the message 43 in the database indicates that it has not been delivered. The processor 3 may use the information in the entry relating to the sent message stored in the database to determine that the predetermined time has expired. If the information has not been deleted by this time, then the processor knows that no delivery report corresponding to that message has been received and therefore that the message has not been delivered.

At step 37 the processor 3 controls the device 1 to present a notification to the user that the message 43 has not been delivered. The notification may be displayed on the display 11 and may also be accompanied by an audio and/or vibration alert. The notification may include a list of options which provide a shortcut to other functions of the device. These functions may allow the user to do something relating to the undelivered message 43, for example send the message 43 to another number, call the intended recipient of the undelivered message 43 or send another message. The identifier stored in the database entry for the message 43 may be used as a search criterion for a personal contacts database, to identify the entry in the contacts database that corresponds to the message identifier. The information contained in the corresponding contacts database entry may be used to enable the functions.

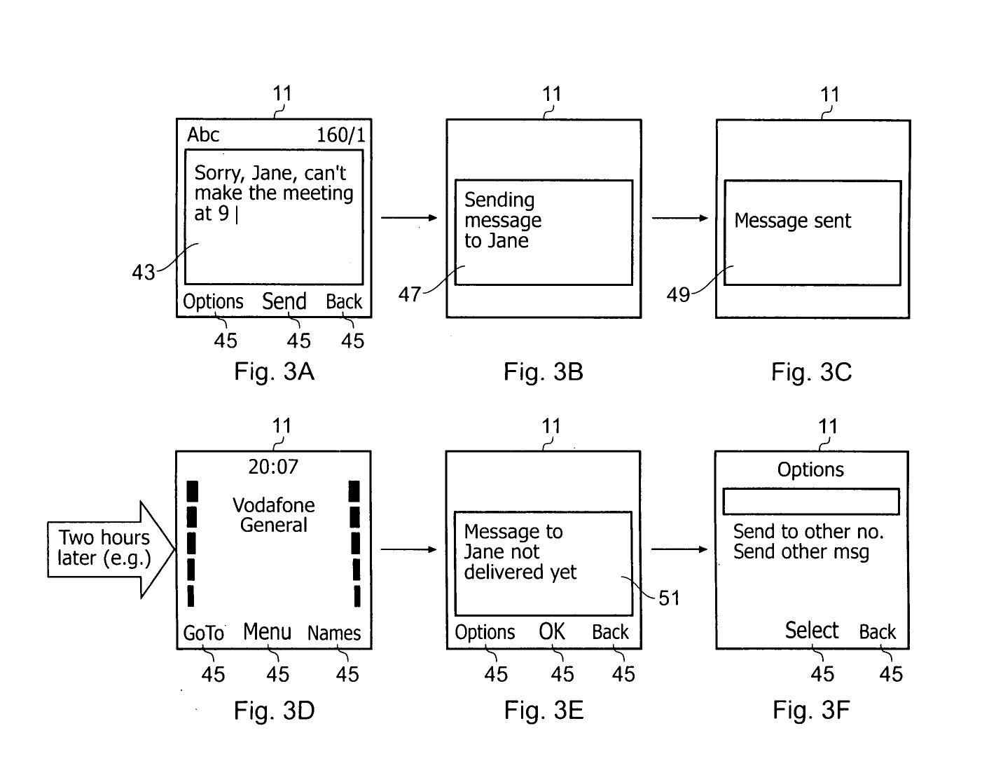

FIGS. 3A to 3F illustrate a user using an embodiment of the present invention. In FIG. 3A an SMS message 43 is displayed on the display 11. This message 43 may have been entered by a user via the user input means 13 or may have been stored in the memory 5 of the device 1. The legends 45 across the bottom of the display 11 indicate the functions of some of the user inputs of the device. According to one embodiment the legends are located directly above the corresponding user inputs. The functions of these user inputs may depend upon the state of the device, therefore, the legends 45 may be different when the device 1 is in a different state.

In FIG. 3B the user has sent the message and a notification 47 is displayed on the display 11 that the device is sending the message 43. In FIG. 3C the display 11 displays a notification 49 that the message 43 has been sent.

In this example the user has arranged the device 1 to present a notification if the message has not been delivered within two hours of being sent. FIG. 3D illustrates the display 11 of the device 1, two hours later, when the device 1 is in the idle state. The legends 45 across the bottom of the display 11 are associated with the functions ‘go to’, ‘menu’ and ‘names’.

In FIG. 3E the device 1 has determined that the message 43 has not been delivered, as described above, and controls the display 11 to display the notification 51 indicating that the message 43 has not been delivered. The legends 45 have changed so that they are now associated with functions ‘options’, ‘ok’ and ‘back’.

By selecting the ‘options’ function the user enters the list of options illustrated in FIG. 3F which allow the user to call the intended recipient, send the message to another number or send another message.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method of managing messages which have been sent by an electronic device comprising:
sending a message from the device;
determining, within the device, whether the message has been delivered within a predetermined time; and
if the message has not been delivered within the predetermined time controlling the device to present a notification to a user of the device that the message has not been delivered.

2. A method as claimed in claim 1 wherein the message is an SMS or an MMS message.

3. A method as claimed in claim 1 comprising storing information relating to the sent message, in a database in the device.

4. A method as claimed in claim 3 wherein the information relating to the sent message includes an indication of the predetermined time.

5. A method as claimed in claim 3 wherein the information relating to the sent message includes an identifier of the sent message.

6. A method as claimed in claim 5 comprising receiving a delivery report wherein the delivery report comprises an identifier of the delivered message.

7. A method as claimed in claim 6 comprising determining whether the identifier of the received delivery report corresponds with the identifier of the sent message, and if there is a correspondence removing the information relating to the sent message from the database.

8. A method as claimed in claim 6 wherein if no delivery report comprising an identifier corresponding to the identifier of the sent message is received within the predetermined time the notification that the message has not been delivered is presented to a user.

9. A method as claimed in claim 1 wherein the notification is a visual notification which is displayed on a display.

10. A method as claimed in claim 1 wherein the notification includes options which provide a shortcut to other functions of the device.

11. A method as claimed in claim 1 wherein the predetermined time is controlled by a user.

12. A method as claimed in claim 1 wherein the predetermined time is the same for all messages sent by the device.

13. A method as claimed in claim 1 wherein the predetermined time is different for each message.

14. A computer program comprising program instructions for causing a computer to perform the method of claim 1.

15. An electronic device comprising:
a transceiver for transmitting and receiving messages;
and control means, for controlling the device, arranged to determine, whether a message, sent by the device, has been delivered within a predetermined time and, if the message has not been delivered within the predetermined time, to present a notification to a user that the message has not been delivered.

16. A device as claimed in claim 15 wherein the message is an SMS or an MMS message.

17. A device as claimed in claim 15 wherein the device comprises a database for storing information relating to the sent message.

18. A device as claimed in claim 15 wherein the information relating to the sent message includes an indication of the predetermined time.

19. A device as claimed in claim 17 wherein the information relating to the sent message includes an identifier of the sent message.

20. A device as claimed in claim 19 wherein the transceiver is arranged to receive a delivery report wherein the delivery report comprises an identifier of the delivered message.

21. A device as claimed in claim 20 wherein the control means is arranged to determine whether the identifier of the received delivery report corresponds with the identifier of the sent message, and if there is a correspondence remove the information relating to the sent message from the data base.

22. A device as claimed in claim 20 wherein the control means present the notification that the message has not been delivered to a user if no delivery report comprising an identifier corresponding to the identifier of the sent message is received within the predetermined time.

23. A device as claimed in claim 15 wherein the device comprises a display for displaying, to a user, the notification that the message has not been delivered.

24. A device as claimed in claim 15 wherein the notification includes options which provide a shortcut to other functions of the device.

25. A device as claimed in claim 15 wherein the predetermined time is controlled by a user.

26. A device as claimed in claim 15 wherein the predetermined time is the same for all messages sent by the device.

27. A device as claimed in claim 15 wherein the predetermined time is different for each message.

28. A computer program comprising program instructions for controlling an electronic device which, when loaded into a processor, provides:
means for correlating information relating to messages sent by the device with notification of delivery messages received by the device; and
means for initiating a notification that a first message, sent by the device, has not been delivered, if a notification of delivery message has not been received and correlated with the first message within a predetermined time.

29. A physical entity embodying the computer program as claimed in claim 28.

30. An electromagnetic carrier signal carrying the computer program as claimed in claim 28.
